(19) United States
(12) Patent Application Publication
(10) Pub. No.: US 2009/0182800 A1
(43) Pub. Date: Jul. 16, 2009

(54) OPERATION SYSTEM OF INTERNET CONNECTED DIGITAL PHOTO FRAME

(75) Inventors: Chi-Chou Lin, Taipei City (TW); Ah-Jee Wang, Taipei City (TW)

Correspondence Address: Muncy, Geissler, Olds & Lowe, PLLC, P.O. BOX 1364, FAIRFAX, VA, 22038-1364, US

(73) Assignee: D-Link Corporation

(21) Appl. No.: 12/062,252

(22) Filed: Apr. 3, 2008

(30) Foreign Application Priority Data
Jan. 15, 2008 (TW) 97101500

(51) Int. Cl. G06F 15/16

(52) U.S. Cl. 709/201

(57) ABSTRACT

An operation system of an internet connected digital photo frame includes local and remote storage units to store digital images, content settings relevant to homepages and connecting lists of groups, respectively. With control tools, a user may manage and edit the digital images and the customized content settings of homepages. Thus, such an internet connected digital photo frame is used as a social interface among the user and groups on internet.

### BACKGROUND OF THE INVENTION

1. Field of the Invention

The present invention relates to an operation system of internet connected digital photo frame, and more specifically, to an operation system of grouping internet connected digital photo frame.

2. Background of the Related Art

Digital photo frame has been a popular small and middle-size display product in the recent years. In a research, the user of digital photo frame tends to directly view and share photos on a display apparatus. Such a behavior model of a customer leads to the design of an internet connected digital photo frame. Generally, a typical digital photo frame is equipped with a LCD screen with a high resolution for displaying photos in a good quality like a conventional photo film. Any amount of digital photos may be easily stored and displayed on the digital photo frame via the connection of a memory card, digital camera or computer. The memory card may be SD, MMC or MS cards, and the playing formats supported by the digital photo frame may be static or motion JPEG, AVI or MGEG, even an audio format of MP3.

Some functions on existing digital photo frames include displaying images in various format stored in the internet, linking to the internet to access the images online and simply managing files. However, people tend to interact and communicate each another with the internet. For example, sharing texts or photos with web logs to friends and relatives is a method gradually accepted by people. Thus, there are still improvements on the design of the internet connected digital photo frames.

### SUMMARY OF THE INVENTION

The present invention provides the operation system of an internet connected digital photo frame. A user integrates various internet connected digital photos at a local portal site and manages them with a utility tool, such as widgets, gadgets, dashboard or web browser. The user utilizes the utility tools to manage up to but not limited to sixty-four internet connected internet connected digital photo frames to share the local or remote files of internet connected digital photos and digital videos.

Further, the present invention provides the operation system of an internet connected digital photo frame. The internet connected digital photo frame directly displays any and all updated contents of various grouped categories from the internet portal site without any intervention from the user once the unit has be authenticated and connected to the internet.

Accordingly, one of embodiments of the present invention provides an operation system of an internet connected internet connected digital photo frame, including digital information managing unit coupled with a local storage unit, a remote storage unit, an output unit and internet camera viewer. The improvement includes: the local storage unit storing a digital information relevant to an objective internet connect internet connected digital photo frame; the remote storage unit storing group-in-network settings and including a sharing classification, wherein the sharing classification provides an information-exchanging setting; the digital information managing unit providing utility tools to manage and edit the digital information and the information-exchanging setting, upload to a server or download to the local storage unit, according to the information-exchanging setting, and managing a plurality of remote internet connected digital photo frames belonging to a group containing the objective internet connected digital photo frame; and the output unit showing the digital information, the utility tools, and showing an internet connected content relevant to the group, according to the group-in-network settings. In addition, the internet connected digital photo frame contents are optionally inserted with advertisement, rss (really simple syndication) feeds and advertisement supported digital contents.

These and other aspects, features and advantages of the present invention can be further understood from the accompanying drawings and description of preferred embodiments.

### BRIEF DESCRIPTION OF THE DRAWINGS

FIG. 1 is a schematic diagram illustrating a relationship of an internet connected digital photo frame and the group thereof in accordance with one embodiment of the present invention.

FIG. 2 is a schematic diagram illustrating the operation system of an internet connected digital photo frame in accordance with the present invention.

### DETAILED DESCRIPTION OF THE INVENTION

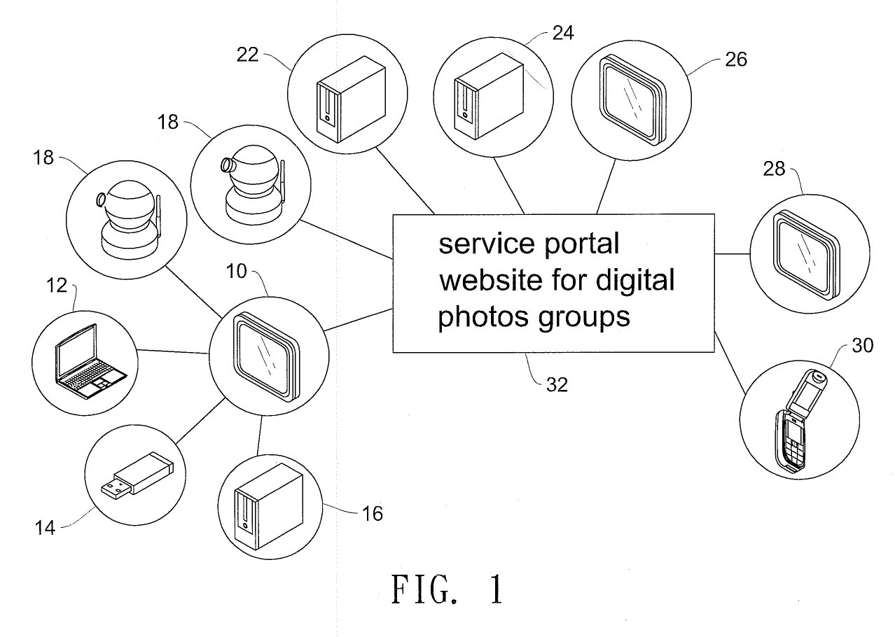

FIG. 1 is a schematic diagram illustrating a relationship of an internet connected digital photo frame and the group thereof in accordance with one embodiment of the present invention. At an objective user's local site, an internet connected digital photo frame 10 is coupled with an apparatus that may provide various files of internet connected digital photos, such as a portable computer 12, universal portable storage 14 or desktop 16, internet camera (IP camera) 18 and so on, but the present invention is not limited to. Alternatively, the internet connected digital photo frame 10 is also coupled with a video apparatus or an audio player (not shown in the figure) for receiving an audio and video file or network broadcast. Accordingly, the internet connected digital photo frame 10 may be used as a center or backup apparatus of internet connected digital photos at the local site for internet connected digital photos integration.

At a remote site compared to the objective user, other people's various digital photos may be stored in different information centers 22 and 24, different digital photo frames 26 and 28, internet camera 18 or a mobile phone 30. The information centers 22 and 24 may provide various platforms to display digital information, such as a storage system for providing web photo or video services. Other people aforementioned are the people belonging to a group and users relevant to the objective user at the local site, such as the user's relatives, friends or people having similar hobbies. Under such a configuration, the internet connected digital photo frames 10, 26 and 28, internet camera 18, mobile phone 30 and information centers 22 and 24 constitute a group in network via the aggregated portal website for internet connected digital photos groups 32. The objective user may use utility tools provided by the internet connected digital photo frame 10 or link the aggregated portal website for internet connected digital photos groups 32 to manage the relationship between the internet connected digital photo frame 10 at the local site and the relevant group at the remote site.

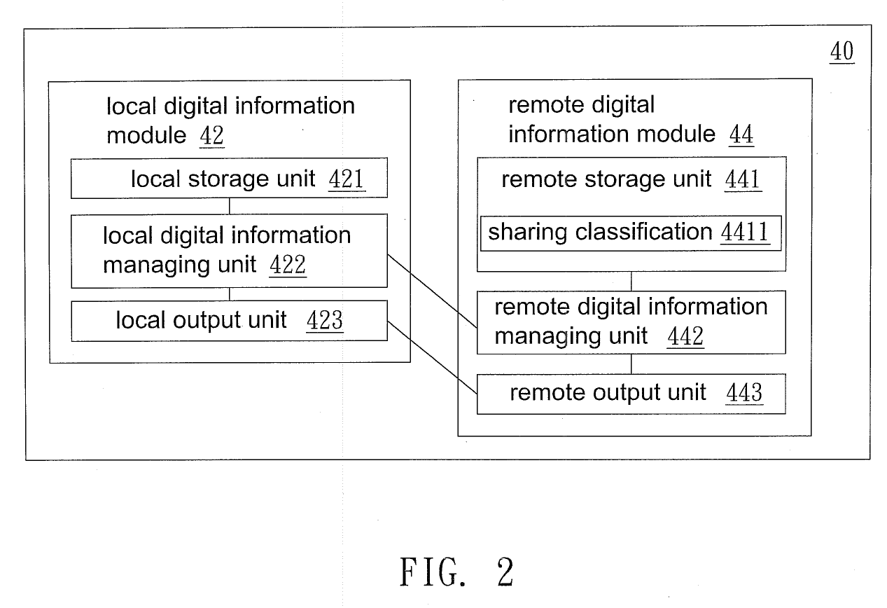

FIG. 2 is a schematic diagram illustrating the operation system of an internet connected digital photo frame in accordance with the present invention. The operation system of the internet connected digital photo frame 40 includes a local digital information module 42 and a remote digital information module 44. In an embodiment, the local digital information module 42 manages the digital information relevant to the objective user's internet connected digital photo frame, which includes a local digital information managing unit 422 coupled with a local storage unit 421 and a local output unit 423. The local storage unit 421 is configured for classifying the digital information stored in the objective internet connected digital photo frame. The digital information may be retrieved from a computer, universal portable storage, internet camera or a mobile phone via a wired transmission line, (eg. Ethernet or USB), a wireless or cellular wireless method. The digital information may be in various formats, such as TIF, PNG, JPG, BMP, GIG or the combination thereof, but not limited to. The classification of the digital information may be done according to source or retrieved time, but not limited to. The local digital information managing unit 422 is configured for managing and editing the digital information stored in the local storage unit 421. In the embodiment, the local digital information managing unit 422 provides the utility tools, which can be shown by a screen (not shown in the figure) via the local output unit 423. The utility tools, such as toolboxes or pull-down menu, may enable the objective user to move the files of the digital information by the drag-and-drop method. The local output unit 423 is configured to display the digital information in the local storage unit 421 and the utility tools provided by the local digital information managing unit 422.

Next, the remote digital information module 44 includes a remote digital information managing unit 442 coupled with a remote storage unit 441 and a remote output unit 443. In the embodiment, the remote storage unit 441 stores the data, settings, or temporary information from and relevant to various remote websites. The remote information may be the internet connected content generated by the model of web content, really simply syndication, social network software or the combination thereof. In the embodiment, the remote aggregated portal websites, such as cross service, inherence or aggregator websites, may be linked with the internet connected digital photo frame of the present invention and display their homepage contents on the internet connected digital photo frame. Thus, the remote storage unit 441 stores settings of customized homepage contents. Next, the internet connected digital photo frame plays a role of sharing platform with the relevant group by storing the group-in-network settings in the remote storage unit 441. The group-in-network settings are a list of relatives and friends for the group, favorite websites, bulletin settings or portal website settings. Furthermore, the remote storage unit 441 includes a sharing classification 4411 storing information-exchanging settings to upload the digital information to a server or download the digital information to the local storage unit 421. The remote digital information managing unit 442 provides the objective user with the utility tools to manage and edit the settings stored in the remote storage unit 441. In the embodiment, with the remote digital information managing unit 442, the customized homepage contents are displayed on the internet connected digital photo frame at preset time. Next, once there is any changed information from the favorite group, such as updated photos, with the remote digital information managing unit 442, the objective user may view or download the updated photos to the remote storage unit 441. Furthermore, once there are changed photos in the local internet connected digital photo frame or updated contents in the local storage unit 421, with the remote digital information managing unit 442, the objective user may transmit them to the aggregated (and non aggregated) portal website to notify the members of the favorite group. The remote output unit 443 is configured for displaying the digital contents set by the remote storage unit 441 and tools provided by the remote digital information managing unit 442.

Alternatively, the local digital information managing unit 422 and the remote digital information managing unit 442 aforementioned are integrated into a digital information managing unit which may include widget utility tools provided by Yahoo or Google, dashboard by MAC, gadget by Microsoft Corporation under the trademark Vista or the combinations thereof to manage and edit the local or remote contents. Next, the local output unit 423 and the remote output unit 443 are also integrated into an output unit to display the local or remote contents at preset time or following a schedule. It is noted that the systems, modules or units in the present invention may be implemented by suitable software, programs, firmware, circuits or hardware elements cooperated with each another. Accordingly, compared to a typical internet connected digital photo frame, the internet connected digital photo frame of the present invention is the member of a group and shares the digital information when linking to the portal website. Once there are any updated photos in the favorite group, the internet connected digital photo frame will be notified via the network. The objective user may decide whether just reviews or download the updated photos via the internet connected digital photo frame. Next, the internet connected digital photo frame may display the customized bulletin selected by the objective user without a computer. Thus, the objective user quickly knows the updated new or information.

Although the present invention has been explained in relation to its preferred embodiment, it is to be understood that other modifications and variation can be made without departing the spirit and scope of the invention as hereafter claimed.

What is claimed is:

1. An operation system of internet connected digital photo frame, comprising a digital information managing unit coupled with a local storage unit, a remote storage unit and an output unit, the improvement comprising:
the local storage unit storing a digital information relevant to an objective internet connected digital photo frame;
the remote storage unit storing group-in-network settings and including a sharing classification, wherein the sharing classification provides an information-exchanging setting;
the digital information managing unit providing utility tools to manage and edit the digital information and the information-exchanging setting, upload to a server or download to the local storage unit, according to the information-exchanging setting, and managing a plurality of remote internet connected digital photo frames belonging to a group containing the objective internet connected digital photo frame; and
the output unit showing the digital information, the utility tools, and showing a homepage content and advertisement inserts relevant to the group, according to the group-in-network settings.

2. An operation system of internet connected digital photo frame according to claim 1, wherein the remote storage unit further stores a setting of customized homepage content.

3. An operation system of internet connected digital photo frame according to claim 1, wherein the group-in-network settings comprise a portal website setting, a list of relatives and friends for the group and a bulletin setting.

4. An operation system of internet connected digital photo frame according to claim 3, wherein the portal website applies a model of web content, really simply syndication, social network software or the combination thereof.

5. An operation system of internet connected digital photo frame according to claim 3, wherein the objective internet connected digital photo frame links to the aggregated portal website and manages the remote internet connected digital photo frames with the digital information managing unit.

6. An operation system of internet connected digital photo frame according to claim 1, wherein the utility tools are widget utility tools, dashboard utility tools, gadget utility tools or the combinations thereof.

7. An operation system of internet connected digital photo frame according to claim 1, wherein the digital information is in formats comprising TIF, PNG, JPG, BMP, GIG or the combination thereof.
